(19) United States
(12) Patent Application Publication
(10) Pub. No.: US 2012/0192269 A1
(43) Pub. Date: Jul. 26, 2012

(54) METHOD FOR REMOTELY CONTROLLING THE EXECUTION OF AT LEAST ONE FUNCTION OF A COMPUTER SYSTEM

(76) Inventor: Stéphane Canet, Versailles (FR)

(21) Appl. No.: 13/497,679

(22) PCT Filed: Sep. 21, 2010
(86) PCT No.: PCT/FR10/51967

§ 371 Date: Apr. 10, 2012

(30) Foreign Application Priority Data
Sep. 22, 2009 (FR) 0956511

(51) Int. Cl. G06F 21/00

(52) U.S. Cl. 726/20

(57) ABSTRACT

A method and a device for remotely controlling the execution of at least one function of a computer system. The method and device are suitable for logging out of a computer application when the user moves a certain distance away from the workstation on which the application is installed. The device includes a mobile identification element (2) having a unique identifier; a computer system (4) with access control; an electronic module forming a base station (3) that can be connected to the computer system (4); a processing system (5) included in the computer system (4), the processing system (5) being capable of communicating with the base station (3) when the latter is connected to the computer system (4).

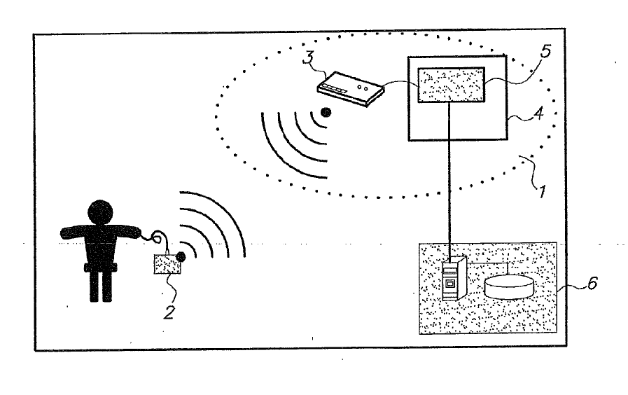

The present invention relates to a method and device for remotely controlling the execution of at least one function of a computer system. It applies in particular, but not exclusively, to a method and device for remotely controlling the closing of a session of a computer application when the user has moved a given distance away from the computer station on which it is installed.

It is known that the preservation of optimal confidentiality of computer data requires, if complete rigor is exercised, that users close their computer session each time they move away, even temporarily, from the computer station on which they are working. However, most of the time, said users neglect, through negligence or ignorance, to close their session after moving away from the respective work stations on which they were working, which amounts to the creation of a security fault that could make it possible to spread confidential information that has thus been made easily accessible.

In order to resolve this problem, methods and devices have been proposed making it possible to detect the presence of an authorized person near a computer so as to allow that person to continue to access some or all of the functions of that computer. Thus, the method and device covered by patent U.S. Pat. No. 6,189,105 make it possible to obtain this result by using a badge worn by the user, in wireless communication with a reader connected to the computer that can control the maintenance of total or partial access to said computer in case of receipt of a correct binary encoded message coming from said badge.

However, the implementation of this method requires the establishment of a continuous or quasi-continuous connection between the badge worn by the user and the reader connected to the computer. Furthermore, the detection of the presence of the badge wearer within a given perimeter around the computer is done by analyzing the disruptions of the electromagnetic field existing in the space comprised between the badge and the reader, which requires the use of signal analysis and processing means, such as signal comparison means, filters, an analog multiplier, etc.

The invention therefore more particularly aims to eliminate these drawbacks. To that end, it proposes a method making it possible to remotely control the execution of at least one function of a computer system, characterized in that it comprises the following steps:
allocating, to each person who may use a computing system such as a computer, a mobile identification means comprising a unique identifier;
connecting, to each computer system, an electronic module making up a base station able to communicate with the mobile identification means as well as with a processing system comprised in the computing system;
determining, after connecting the electronic module to the computing system, mobile identification means whereof the holders are authorized to access the computer system;
determining the distance separating these mobile identification means from the base station so as to define a perimeter beyond which the execution of a function of the computing system is commanded;
determining, for each holder authorized to access the computing system, the remotely controlled function(s) in the event the holder is no longer within said perimeter;
the entry, within the perimeter thus determined around the computing system, of a person bearing a mobile identification means, authorized to access the computing system, this mobile identification means transmitting at regular intervals, or upon request by the base station, a specific identification signal comprising the unique identifier;
reception of that signal by the base station;
determining and/or analyzing, by the base station, at least one characteristic of said detected identification signal in order to deduce the presence or absence of that mobile identification means in said perimeter;
in the event the mobile identification means is determined as being within the perimeter, the base station commands the processing system to allow total or partial access by the holder of the mobile identification means to the computing system;
otherwise, the base station commands the processing system to execute said function(s) generally aiming to restrict or completely prevent access by the holder to the computer system.

In this way, the transmission at regular intervals, or upon request by the base station, and non-continuously, of the identification signal by the mobile identification means makes it possible to reduce the transmission durations of the signals. Furthermore, preferably, the base station analyzes the power of said identification signal, which makes it possible to determine in a simple way the distance between the mobile identification means and the base station associated with it.

Preferably, the determination of the mobile identification means authorized to access the computing system can be done by the receipt of a message by the base station coming from said mobile identification means.

According to one preferred embodiment, the determination of the transmission power of said detected identification signal is accompanied beforehand by filtering, smoothing, and clipping of the power measurements of the received identification signal whereof one wishes to determine the power.

The mobile identification means and the electronic module can each comprise:
communication means;
data processing means, such as a microcontroller;
electrical power means, such as a battery.

According to one alternative embodiment, the device implemented by the method according to the invention can also comprise a centralized control system that can communicate with one or more processing systems, which advantageously makes it possible to collect the information transmitted by the mobile identification means.

One embodiment of the invention will be described below, as a non-limiting example, in reference to the appended drawing, in which:

The sole FIGURE is a diagrammatic illustration of the device implemented by the inventive method.

In this example, the device 1 for implementing the method according to the invention comprises:
a mobile identification means 2 comprising a unique identifier; this mobile identification means 2 can for example consist of a badge, a badge holder, a monitoring bracelet, etc.; furthermore, this mobile identification means 2 can comprise a command interface, such as a keyboard or a simple control button making it possible to command the transmission of a message to a base station 3, consisting of an identification signal comprising the unique identifier; each mobile identification means 2 comprises:
   means for transmitting and/or receiving data signals;
   data processing means, such as a microcontroller;
   electrical power means, such as a battery;
a computing system 4 whereof one wishes to control access; this computing system 4 can be a traditional computer comprising a central unit and a man-machine interface such as a screen-keyboard assembly;
an electronic module constituting a base station 3 that can be connected to a computing system 4 of the aforementioned type; this electronic module comprises:
   means for transmitting and/or receiving data signals;
   data processing means, such as a microcontroller;
   electrical power means, such as a battery;
a processing system 5 comprised in the computing system 4, this processing system 5 being able to communicate with the base station 3 when the latter is connected to said computing system 4; the processing system 5 can assume the form of an application that can be installed on a storage means of the computing system 4, such as a hard disk.

Advantageously, the mobile identification means 2 can comprise several control buttons, each of these buttons corresponding to the transmission of a specific message associated with a determined function, such as, for example, in particular:
the function aiming to prevent access by said holder of the mobile identification means 2 to the computing system 4;
the function aiming to allow access by said holder of the mobile identification means 2 to the computing system 4; these last two functions preferably being reserved for the holders of mobile identification means 2 having the capacity of supervisors;
the function aiming to cause the extinction of the computer system 4.

This device 1 can also comprise a centralized control system 6 that can communicate with one or more processing system 5, which makes it possible to collect the information transmitted by the mobile identification means 2. This centralized control system 6 can be made up of a computer server.

Thus, after having installed the processing system 5 on a storage means of the computer system 4, and having connected the base station 3 to said computing system 4, a user with a supervisory capacity can configure at least one of the following parameters:
the determination of the distance separating the mobile identification means 2 from the base station 3 so as to define a perimeter beyond which the execution of at least one function of the computing system 4 is commanded;
the association of said base station 3 with at least one mobile identification means 2;
the analysis of the existing radio-environmental characteristics, in the space around the computing system 4;
the determination, in particular as a function of this analysis, of the power level threshold of the transmission signal of each of the mobile identification means 2 below which these mobile identification means 2 will be considered to be outside said perimeter;
the filtering, smoothing, clipping parameters and generally, any parameter making it possible to calculate and correct the power measurement of said transmission signal received by the base station 3;
the measurements making it possible to determine the transmission power of the mobile identification means 2 and the reception sensitivity of the base station 3.

In this way, the base station 3 ensures at regular intervals that the mobile identification means 2 is in said perimeter, by proceeding with the detection and analysis of the identification signal emitted at regular intervals, or upon solicitation of the base station 3, by this mobile identification means 2. The analysis of the identification signal can thus consist of determining its power, which makes it possible to determine in a simple way the distance between the mobile identification means 2 and the base station 3 assigned to it. If the mobile identification means 2 is indeed associated with the base station 3 of the computer system 4, it is then possible to distinguish three cases:
the base station 3 connected to the computer system 4 does not detect any identification signal; the base station 3 then commands the processing system 5 to execute a function aiming to restrict or completely prevent access by said holder to the computing system 4;
the base station 3 connected to the computing system 4 detects an identification signal whereof the power is below said locking threshold; the base station 3 then commands the processing system 5 to execute a function aiming to restrict or completely prevent access by said holder to the computing system 4;
the base station 3 connected to the computing system 4 detects an identification signal whereof the power is above said threshold; the base station 3 then commands the processing system 5 to execute a function allowing total or partial access by the holder of the mobile identification means 2 to the computing system 4.

Of course, if no base station 3 is connected to the computing system 4, the processing system 5 locks access to the computing system 4.

As a non-limiting example, the measurement of the power of the identification signal can be done based on the RSSI (“Received Signal Strength Indication”), the measurement of which evolves in a predetermined range as a function of the intensity of said received identification signal.

Advantageously, in particular in order to go back into a more linear range of the RSSI, the transmission power of the signals emitted by the mobile identification means 2 may be reduced.

According to one alternative embodiment of the invention, the analysis of said identification signal can also consist of:
measuring the LQI (“Link Quality Indicator”), which makes it possible to obtain an indication of the quality of the data packets received by the base station 3, by measuring the level of incomplete or altered messages received; and/or
measuring the propagation time of the identification signal between the mobile identification means 2 and the base station 3, which can each comprise a clock that can be synchronized after having connected the base station 3 to the computing system 4; and/or
measuring the phase shift of the wireless identification signal between the mobile identification means 2 and the base station 3; and/or
measuring the time difference between the reception either by the identification means 2 or by the base station 3 of a wireless signal and an ultrasound signal emitted by one of these two entities 2, 3, the ultrasound signal being emitted immediately after the end of the transmission of the wireless signal; and/or
measuring the phase shift at the receiving entity 2, 3 between the electric field and the magnetic field, knowing that such a phase shift exists between the antenna and a distance that in particular depends on the wavelength of the wireless signal, the emitting entity 2, 3 being configured to emit in a suitable frequency range.

According to one preferred embodiment of the invention, when the holder of the mobile identification means 2 returns into said perimeter after having left it, the base station 3 detects whether the analyzed characteristic(s) of the identification signal, such as the power level of the identification signal of said identification means 2, is evolving in a determined range. If, for example, the power level of the signal is again above the locking threshold, this results in the emission by the base station 3 of an instruction commanding the processing system 5 so as to allow total or partial access by the holder of the mobile identification means 2 to the computing system 4.

According to one preferred embodiment of the invention, the data exchanged between the mobile identification means 2, the base station 3 and the processing system 5 could be encrypted, the centralized control system 6 being able to proceed with the regular renewal of the encryption keys.

The location of the mobile identification means 2 may be done using other methods, such as the triangulation method, in this case associating at least one second base station 3 with the computing system 4.

According to one alternative embodiment of the invention, the detection of the location using the mobile identification means 2 can be done by proceeding with an adaptation of the emission power of the signals as a function of the size of the perimeter beyond which the execution of a function of the computing system 4 is commanded.

Thus, beyond said locking perimeter, the signals can no longer be picked up by the base station 3, which establishes that the mobile identification means 2 is no longer situated in said perimeter.

According to one alternative embodiment, the mobile identification means 2 or the base station 3 can emit several identical signals by using a specific frequency for each signal. In this way, it is possible to optimize the quality of the signals received by the receiving entity 2, 3.

The mobile identification means 2 and the base station 3 can thus respectively comprise:
at least two transmitters and at least two corresponding receivers, which each operate with a different specific frequency, the signals then being able to be transmitted simultaneously or one after the other; or
a single transmitter and a single receiver able to generate and receive signals having different frequencies, these signals being emitted one after the other.

According to another alternative embodiment of the invention, the waves corresponding to the signals transmitted between the mobile identification means 2 and the base station 3 are polarized in order to minimize echoes.

The mobile identification means 2 and the base station 3 can thus each comprise at least two antennas used simultaneously to transmit a same signal phase-shifted appropriately between these two antennas.

In general, the mobile identification means 2 and the base station 3 can each comprise several antennas making it possible to:
emit and/or receive signals simultaneously or successively according to a multiplexing method;
reduce the problems related to the losses of information from the signal, or an excessive intensity of the signal upon reception, by positioning the antennas according to specific orientations and spacings (the distance between two antennas preferably corresponds to a fraction of the wavelength of the emitted signal), a specific position of the antennas also being able to make it possible to make the radiation of each antenna directive and rotating.

According to one alternative embodiment of the invention, a detection of the movements of a mobile identification means 2 can be done for example using an accelerometer, a gyrometer, or an inertial unit comprised in said identification means 2.

In this way, it is possible to overcome the problem constituted by the fact that the pivoting of the wearer of a mobile identification means 2, for example seated on a pivoting chair, can cause the locking of the computer to which the base station 3 is connected due to the fact that the latter no longer picks up the waves emitted by the identification means 2, the human body forming a screen against the propagation of those waves. Using a device such as an accelerometer makes it possible to determine whether the waves are no longer picked up due to distancing or turning.

According to one preferred embodiment of the invention, each mobile identification means 2 only emits an identification signal in response to a signal regularly emitted by the base station 3, which advantageously makes it possible to reduce the actual operating time of the power supply means of said mobile identification means 2, the latter being able by default to be in “stand-by” mode or in “sleep” mode. In this way, when it is not solicited, the mobile identification means 2 does not consume energy. Advantageously, this alternative embodiment makes it possible to avoid collisions due to simultaneous responses by different mobile identification means 2. In fact, if the base station 3 sends a wireless message comprising the unique identifier of the mobile identification means 2 associated with it, only that mobile identification means 2 will respond to the solicitation of the base station 3, thereby avoiding collisions between responses.

According to another preferred alternative embodiment of the invention, when the energy level of the power supply means of a mobile identification means 2 becomes insufficient, the latter may emit a sound or light warning, and/or transmit that information to the corresponding base station 3. That base station 3 may comprise an electric charger, preferably powered by the USB (“Universal Serial Bus”) port of the computing system 4, which comprises a connector configured so as to be able to connect said power supply means of the mobile identification means 2.

In this way, when it becomes necessary to recharge the power supply means of a mobile identification means 2, the user may, after having removed them from their housing, connect them to said connector of the base station 3, the recharging thus being able to be done without risk of leaving the mobile identification means 2 unmonitored.

Preferably, in case of deliberate or accidental disconnection of the base station 3 from the computing system 4, the processing system 5 will command the immediate locking of said computing system 4.

According to another alternative embodiment of the invention, the mobile identification means 2 can comprise a touch control means making it possible to transmit to the centralized control system 6, via the processing system 5, as well as via the base station 3, the information according to which the computing system 4 will be extinguished and will no longer be “visible” on the network, the transmission of that information to the centralized control system 6 being able to be encrypted.

In this way, only a wearer of a mobile identification means 2 can turn off the corresponding computing system 4 and make it “disappear” from the network, any “disappearance” not preceded by the emission of a warning message to the centralized control system 6 thus having to be considered suspicious. The sending of this shut-down notification from the processing system 5 to the centralized system 6 can be subject to a return receipt sent by the centralized system 6 to the processing system 5, which thus makes it possible to control the actual shut-down of the computing system 4.

Advantageously, the method according to one alternative embodiment of the invention can make it possible to control whether the elements associated with a mobile identification means 2 of the aforementioned type pass (or do not pass) through a defined perimeter around a base station 3.

Thus, each element to be monitored is comprised or connected to a mobile identification means 2 of the aforementioned type, having a unique identifier that can appear in a specific identification signal emitted by the mobile identification means 2 toward a base station 3.

The base station 3 can be connected to alert means that are triggered in the event the mobile identification assembly 2—element to be monitored enters and/or leaves the perimeter.

The determination of the size of the perimeter and the detection by the base station 3 of crossing thereof by a mobile identification means 2 is done by carrying out the steps of the method previously described.

1. A method making it possible to remotely control the execution of at least one function of a computer system (4), characterized in that it comprises the following steps:
allocating, to each person who may use a computing system (4), a mobile identification means (2) comprising a unique identifier;
connecting, to each computer system (4), an electronic module making up a base station (3) able to communicate with the mobile identification means (2) as well as with a processing system (5) comprised in the computing system (4);
determining, after connecting the electronic module (3) to the computing system (4), mobile identification means (2) whereof the holders are authorized to access the computer system (4);
determining the distance separating these mobile identification means (2) from the base station (3) so as to define a perimeter beyond which the execution of a function of the computing system (4) is commanded;
determining, for each holder authorized to access the computing system (4), the remotely controlled function(s) in the event the holder is no longer within said perimeter;
the entry, within the perimeter thus determined around the computing system (4), of a person bearing a mobile identification means (2), authorized to access the computing system (4), this mobile identification means (2) transmitting at regular intervals, or upon request by the base station (3), a specific identification signal comprising the unique identifier;
reception of that signal by the base station (3);
determining and/or analyzing, by the base station (3), at least one characteristic of said detected identification signal in order to deduce the presence or absence of that mobile identification means (2) in said perimeter;
in the event the mobile identification means (2) is determined as being within the perimeter, the base station (3) commands the processing system (5) to allow total or partial access by the holder of the mobile identification means (2) to the computing system (4);
otherwise, the base station (3) commands the processing system (5) to execute said function(s) generally aiming to restrict or completely prevent access by the holder to the computer system.

2. The method according to claim 1, characterized in that said function(s) whereof the execution is controlled remotely by the base station (3) aim(s) to restrict or completely prevent access by said holder to the computer system (4).

3. The method according to claim 1, characterized in that it comprises the determination by the base station (3) of the emission power of said detected identification signal in order to deduce the presence or absence of said mobile identification means (2) within said perimeter, the emission power then being the characteristic of the determined and/or analyzed identification signal.

4. The method according to claim 1, characterized in that after having installed the processing system (5) on a storage means of the computing system (4), and connected the base station (3) to said computing system (4), a user having a supervisory function can configure at least one of the following parameters:
the determination of the distance separating the mobile identification means (2) from the base station (3) so as to define a perimeter beyond which the execution of at least one function of the computing system (4) is commanded;
the association of said base station (3) with at least one mobile identification means (2);
the analysis of the existing radio-environmental characteristics, in the space around the computing system (4);
the determination, in particular as a function of this analysis, of the power level threshold of the transmission signal of each of the mobile identification means (2) below which these mobile identification means (2) will be considered to be outside said perimeter;
the filtering, smoothing, clipping parameters and generally, any parameter making it possible to calculate and correct the power measurement of said transmission signal received by the base station (3);
the measurements making it possible to determine the transmission power of the mobile identification means (2) and the reception sensitivity of the base station (3).

5. The method according to claim 1, characterized in that the data exchanged between the mobile identification means (2), the base station (3) and the processing system (5) are encrypted, the centralized control system (6) being able to communicate with one or more processing systems (5) can proceed with the regular renewal of the encryption keys.

6. The method according to claim 1, characterized in that each mobile identification means (2) only emits an identification signal in response to a signal regularly emitted by the base station (3), which makes it possible to reduce the actual operating time of the power supply means of said mobile identification means (2), the latter being able by default to be in “stand-by” mode or in “sleep” mode.

7. The method according to claim 1, characterized in that when the energy level of the power supply means of a mobile identification means (2) becomes insufficient, the latter emits a sound or light warning, and/or transmits that information to the corresponding base station (3), which comprises an electric charger, which comprises a connector configured to be able to connect said power supply means of the mobile identification means (2).

8. The method according to claim 5, characterized in that the information according to which the computing system (4) will be extinguished and will no longer be “visible” on the network is transmitted to the centralized control system (6), via the processing system (5), as well as via the base station (3) through a touch control means comprised in/on the mobile identification means (2).

9. The method according to claim 8, characterized in that the sending of this shut-down notification from the processing system (5) to the centralized system (6) is subject to a return receipt sent by the centralized system (6) to the processing system (5), which thus makes it possible to control the actual shut-down of the computing system (4).

10. The method according to claim 1, characterized in that it makes it possible to control whether the elements associated with a mobile identification means (2) pass (or do not pass) through a defined perimeter around a base station (3), each element to be monitored being comprised or connected to a mobile identification means (2) having a unique identifier that can appear in a specific identification signal emitted by the mobile identification means (2) to a base station (3); in the event the mobile identification assembly (2)—element to be monitored enters and/or leaves the perimeter, alert means connected to the base station (3) are triggered.

11. The method according to claim 3, characterized in that the determination of the emission power of said detected identification signal is accompanied by the filtering, smoothing and clipping of the power measurements of the received identification signal whereof one wishes to determine the power.

12. The method according to claim 2, characterized in that the determination of the mobile identification means (2) authorized to access the computing system (4) is done by the reception of a message by the base station (3) coming from said mobile identification means (2).

13. The method according to claim 3, characterized in that the measurement of the power of the identification signal is done based on the RSSI (“Received Signal Strength Indication”), the measurement of which evolves in a predetermined range as a function of the intensity of said received identification signal.

14. The method according to claim 1, characterized in that the analysis of the identification signal consists of:
measuring the LQI (“Link Quality Indicator”), which makes it possible to obtain an indication of the quality of the data packets received by the base station (3), by measuring the level of incomplete or altered messages received; and/or
measuring the propagation time of the identification signal between the mobile identification means (2) and the base station (3), which can each comprise a clock that can be synchronized after having connected the base station (3) to the computing system (4); and/or
measuring the phase shift of the wireless identification signal between the mobile identification means (2) and the base station (3); and/or
measuring the time difference between the reception either by the identification means (2) or by the base station (3) of a wireless signal and an ultrasound signal emitted by one of these two entities (2, 3), the ultrasound signal being emitted immediately after the end of the transmission of the wireless signal; and/or
measuring the phase shift at the receiving entity (2, 3) between the electric field and the magnetic field, knowing that such a phase shift exists between the antenna and a distance that in particular depends on the wavelength of the wireless signal, the emitting entity (2, 3) being configured to emit in a suitable frequency range.

15. The method according to claim 3, characterized in that the detection of the location of the mobile identification means (2) is done by proceeding with an adaptation of the emission power of the signals as a function of the size of the perimeter beyond which the execution of a function of the computing system (4) is commanded.

16. The method according to claim 1, characterized in that the mobile identification means (2) or the base station (3) emits several identical signals by using a specific frequency for each signal; in this way, the quality of the signals received by the receiving entity (2, 3) can be optimized.

17. The method according to claim 1, characterized in that the waves corresponding to the signals transmitted between the mobile identification means (2) and the base station (3) are polarized in order to minimize echoes; the mobile identification means (2) and the base station (3) comprise at least two antennas used simultaneously to transmit a same signal phase-shifted appropriately between these two antennas

18. The method according to claim 1, characterized in that a detection of the movements of the mobile identification means (2) is done using an accelerometer, a gyrometer, or an inertial unit comprised in said identification means (2).

19. A device for implementing the method according to claim 1, characterized in that it comprises:
a mobile identification means (2) comprising a unique identifier; each mobile identification means (2) comprises:
means for transmitting and/or receiving data signals;
data processing means, such as a microcontroller;
electrical power means, such as a battery;
a computing system (4) whereof one wishes to control access;
an electronic module constituting a base station (3) that can be connected to a computing system (4) of the aforementioned type; this electronic module (3) comprises:
means for transmitting and/or receiving data signals;
data processing means, such as a microcontroller;
electrical power means, such as a battery;
a processing system (5) comprised in the computing system (4), this processing system (5) being able to communicate with the base station (3) when the latter is connected to said computing system (4); the processing system (5) can assume the form of an application that can be installed on a storage means of the computing system (4).

20. The device according to claim 19, characterized in that it comprises a centralized control system (6) able to communicate with one or more processing systems (5), which makes it possible to collect the information transmitted by the mobile identification means (2).

21. The device according to claim 19, characterized in that the mobile identification means (2) consists of a badge, a badge holder, a monitoring bracelet, and in that it comprises a command interface making it possible to command the emission of a message to a base station (3).

22. The device according to claim 19, characterized in that the mobile identification means (2) comprises control buttons, each of these buttons corresponding to the transmission of a specific message associated with a determined function, such as:
the function aiming to prevent access by said holder of the mobile identification means (2) to the computing system (4);
the function aiming to allow access by said holder of the mobile identification means (2) to the computing system (4); these last two functions preferably being reserved for the holders of mobile identification means (2) having the capacity of supervisors;
the function aiming to cause the extinction of the computer system (4).

23. The device according to claim 19, characterized in that the mobile identification means (2) and the base station (3) respectively comprise:
at least two transmitters and at least two corresponding receivers, which each operate with a different specific frequency, the signals then being able to be transmitted simultaneously or one after the other; or
a single transmitter and a single receiver able to generate and receive signals having different frequencies, these signals being emitted one after the other.

24. The device according to claim 19, characterized in that the mobile identification means (2) and the base station (3) each comprise at least two antennas used simultaneously to transmit a same signal phase-shifted appropriately between these two antennas, which makes it possible to polarize the waves corresponding to the signals transmitted between the mobile identification means (2) and the base station (3).

25. The device according to claim 19, characterized in that the mobile identification means (2) and the base station (3) each comprise several antennas making it possible to:
emit and/or receive signals simultaneously or successively according to a multiplexing method;
reduce the problems related to the losses of information from the signal, or an excessive intensity of the signal upon reception, by positioning the antennas according to specific orientations and spacing, a specific position of the antennas also being able to make it possible to make the radiation of each antenna directive and rotating.

26. The device according to claim 19, characterized in that the mobile identification means (2) comprises an accelerometer, a gyrometer or an inertial unit.
